(19) United States
(12) Patent Application Publication
(10) Pub. No.: US 2020/0290648 A1
(43) Pub. Date: Sep. 17, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Yoshitaka Mimura, Wako-shi (JP); Katsuyasu Yamane, Wako-shi (JP); Hiroshi Yamanaka, Wako-shi (JP); Chie Sugihara, Tokyo (JP); Yuki Motegi, Tokyo (JP); Tsubasa Shibauchi, Tokyo (JP)

(21) Appl. No.: 16/809,595

(22) Filed: Mar. 5, 2020

(30) Foreign Application Priority Data
Mar. 11, 2019 (JP) 2019-043697

(51) Int. Cl. B60W 60/00; B60W 10/04; B60W 10/20; B60Q 3/80; B60W 30/06

(52) U.S. Cl. CPC B60W 60/00253; B60W 10/04; B60W 10/20; B60Q 3/80; B60W 2540/041; B60W 2720/10; B60W 2720/12; B60W 2710/20; B60W 30/06

(57) ABSTRACT

A vehicle control system includes: a recognizer configured to recognize a surrounding environment of a vehicle; a driving controller configured to perform at least one of speed control and steering control of the vehicle based on a recognition result of the recognizer; an acquirer configured to acquire a feature of an outer appearance of a person near the vehicle and store the feature of the outer appearance in a memory; a gesture recognizer configured to recognize a gesture of the person; and a determiner configured to determine whether features of the outer appearance of the person acquired at different timings by the acquirer match. The determiner is configured to determine whether a feature of an outer appearance of the person acquired by the acquirer at a first timing at which the person boards the vehicle matches a feature of the outer appearance of the person acquired by the acquirer at a second timing which is a timing later than the first timing and at which the gesture recognizer recognizes that the person is performing a predetermined gesture. The driving controller is configured to cause the vehicle to stop near the person of which the features are determined to match when the determiner determines that the features match.

### CROSS-REFERENCE TO RELATED APPLICATION

Priority is claimed on Japanese Patent Application No. 2019-043697, filed Mar. 11, 2019, the content of which is incorporated herein by reference.

### BACKGROUND

### Field of the Invention

The present invention relates to a vehicle control system, a vehicle control method, and a storage medium.

### Description of Related Art

In recent years, studies of automated vehicle control have been conducted. In relation to this technology, a technology for allowing an occupant of a vehicle to register an image captured in advance and stopping the vehicle near the occupant in accordance with a gesture of the occupant when a feature of the occupant shown in an image captured by an imaging device mounted in the vehicle returned automatically matches a feature of the occupant shown in the image registered in advance is known (for example, see Japanese Unexamined Patent Application, First Publication No. 2017-121865).

### SUMMARY

In the technology of the related art, however, when an occupant is thickly clad or an appearance is different from at a usual time, a feature of the occupant shown in an image captured in advance differs from a feature of the occupant shown in an image captured by an imaging device mounted in a vehicle, and thus it is difficult to cause the vehicle to stop near the occupant in accordance with a gesture of the occupant.

The present invention is devised in view of such circumstances and an objective of the present invention is to provide a vehicle control system, a vehicle control method, and a storage medium capable of stopping a vehicle near an occupant with high precision.

A vehicle control device, a vehicle control system, a vehicle control method, and a storage medium according to the present invention adopt the following configurations.

(1) According to an aspect of the present invention, a vehicle control system includes: a recognizer configured to recognize a surrounding environment of a vehicle; a driving controller configured to perform at least one of speed control and steering control of the vehicle based on a recognition result of the recognizer; an acquirer configured to acquire a feature of an outer appearance of a person near the vehicle and store the feature of the outer appearance in a memory; a gesture recognizer configured to recognize a gesture of the person; and a determiner configured to determine whether features of the outer appearance of the person acquired at different timings by the acquirer match. The determiner is configured to determine whether a feature of an outer appearance of the person acquired by the acquirer at a first timing at which the person boards the vehicle matches a feature of the outer appearance of the person acquired by the acquirer at a second timing which is a timing later than the first timing and at which the gesture recognizer recognizes that the person is performing a predetermined gesture. The driving controller is configured to cause the vehicle to stop near the person of which the features are determined to match when the determiner determines that the features match.

(2) In the vehicle control system according to the aspect (1), the determiner may determine whether a feature at the first timing stored in the memory immediately before the second timing matches a feature acquired at the second timing.

(3) The vehicle control system according to the aspect (1) may further include an illumination controller configured to control an illumination provided in the vehicle. The illumination controller may turn on the illumination in a predetermined lighting aspect when the feature acquired by the acquirer does not match the feature stored in the memory with regard to the person who is recognized to be performing the predetermined gesture by the gesture recognizer.

(4) The vehicle control system according to the aspect (1) may further include a driving controller configured to drive a movable part provided in the vehicle. The driving controller may drive the movable part in a predetermined driving aspect when the feature acquired by the acquirer does not match the feature stored in the memory with regard to the person who is recognized to be performing the predetermined gesture by the gesture recognizer.

(5) According to another aspect of the present invention, a vehicle control method is configured to cause a computer: to recognize a surrounding environment of a vehicle; to automatically perform at least one of speed control and steering control of the vehicle based on a recognition result; to acquire a feature of an outer appearance of a person near the vehicle and store the feature of the outer appearance in a memory; to recognize a gesture of the person; to determine whether features of the outer appearance of the person acquired at different timings by the acquirer match; to determine whether a feature of an outer appearance of the person acquired at a first timing at which the person boards the vehicle matches a feature of the outer appearance of the person acquired at a second timing which is a timing later than the first timing and at which the person is recognized to be performing a predetermined gesture; and to cause the vehicle to stop near the person of which the features are determined to match when the features are determined to match.

(6) According to still another aspect of the present invention, a computer-readable non-transitory storage medium stores a program causing a computer: to recognize a surrounding environment of a vehicle; to automatically perform at least one of speed control and steering control of the vehicle based on a recognition result; to acquire a feature of an outer appearance of a person near the vehicle and store the feature of the outer appearance in a memory; to recognize a gesture of the person; to determine whether features of the outer appearance of the person acquired at different timings by the acquirer match; to determine whether a feature of an outer appearance of the person acquired at a first timing at which the person boards the vehicle matches a feature of the outer appearance of the person acquired at a second timing which is a timing later than the first timing and at which the person is recognized to be performing a predetermined gesture; and to cause the vehicle to stop near the person of which the features are determined to match when the features are determined to match.

According to the aspects (1) to (6), it is possible to cause the vehicle to stop near the occupant with high precision.

According to the aspects (3) and (4), it is possible to show a response with amusement to a person other than the occupant.

### BRIEF DESCRIPTION OF THE DRAWINGS

FIG. 1 is a diagram showing a configuration of a vehicle control system in which a vehicle control device is used according to a first embodiment.

FIG. 2 is a diagram showing a functional configuration of first and second controllers.

FIG. 3 is a diagram schematically showing a scenario in which an autonomous parking event is performed.

FIG. 4 is a diagram showing an example of a configuration of a parking lot management device.

FIG. 5 is a diagram showing an example of content of outer appearance feature information.

FIG. 6 is a diagram showing an example of a feature of an outer appearance of an occupant at the normal time.

FIG. 7 is a diagram showing an example of a feature of an outer appearance of an occupant on a cold day.

FIG. 8 is a diagram showing a scenario in which a person other than an occupant performs a predetermined gesture on the own vehicle M.

FIG. 9 is a flowchart showing an example of a series of operations of the automated driving control device according to the embodiment.

FIG. 10 is a diagram showing an example of a hardware configuration of an automated driving control device according to an embodiment.

### DESCRIPTION OF EMBODIMENTS

### Embodiment

Hereinafter, an embodiment of a vehicle control system, a vehicle control method, and a storage medium according to the present invention will be described with reference to the drawings. Hereinafter, a case in which laws and regulations for left-hand traffic are applied will be described. However, when laws and regulations for right-hand traffic are applied, the left and right may be reversed.

### [Overall Configuration]

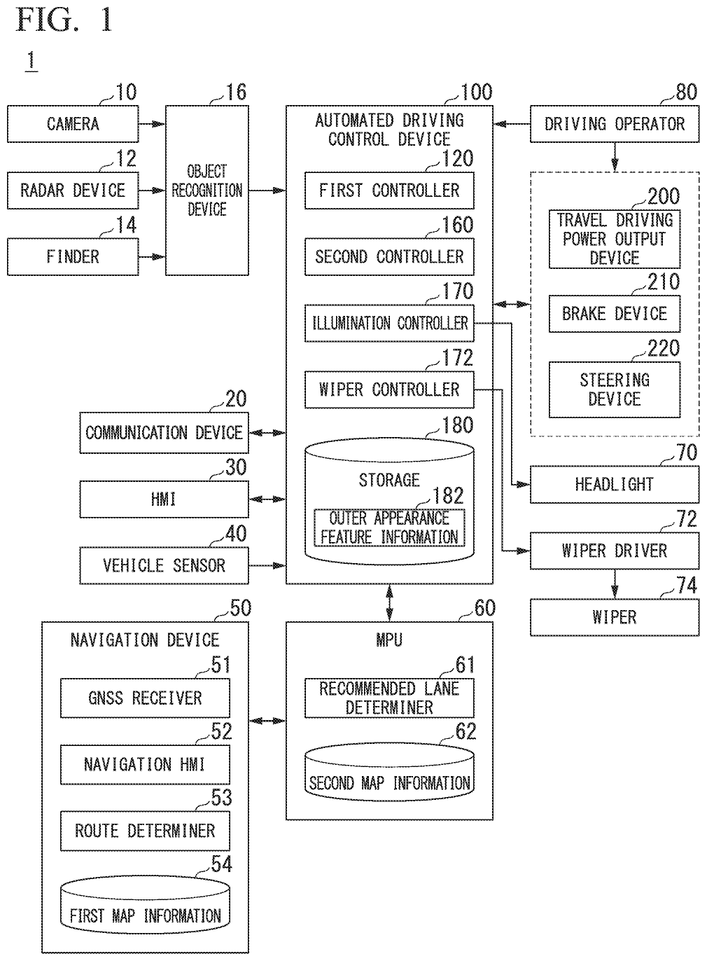

FIG. 1 is a diagram showing a configuration of a vehicle system 1 in which a vehicle control device according to a first embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely an exemplary example, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as an own vehicle M). For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with other vehicles around the own vehicle M using, for example, a cellular network, a Wi-Fi network, Bluetooth (registered trademark), dedicated short range communication (DSRC) or the like or communicates with a parking lot management device (to be described below) or various server devices.

The HMI 30 presents various types of information to occupants of the own vehicle M and receives input operations by the occupants. For example, the HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information.

The route on the map is output to the MPU 60. The navigation device 50 may perform route guidance using the navigation HMI 52 based on the route on the map. The navigation device 50 may be realized by, for example, a function of a terminal device (hereinafter referred to as a terminal device TM) such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The headlight 70 radiates light toward the front side of the own vehicle M by being turned on. The automated driving control device 100 controls the headlight 70 such that the headlight 70 is turned on and off.

A wiper driver 72 drives the wiper 74 under the control of the automated driving control device 100. The wiper driver 72 is realized by, for example, a motor. The wiper driver 72 performs driving under the control of the automated driving control device 100. A wiper 74 is mounted in the wiper driver 72 and wipes a window of the own vehicle M in accordance with driving of the wiper driver 72 to wipe rain drops and stains attached on the window. For example, the wiper 74 is provided in a front window and/or a rear window of the own vehicle M.

The driving operator 80 includes, for example, an accelerator pedal, a brake pedal, a shift lever, a steering wheel, a heteromorphic steering wheel, a joystick, and other operators. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120, a second controller 160, and an illumination controller 170, a wiper controller 172, and a storage 180. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a storage medium (a non-transitory storage medium) detachably mounted on a DVD, a CD-ROM, or the like so that the storage medium is mounted on a drive device to be installed on the HDD or the flash memory of the automated driving control device 100. The storage 180 stores outer appearance feature information 182. The details of the outer appearance feature information 182 will be described later. The storage 180 is an example of a “memory.”

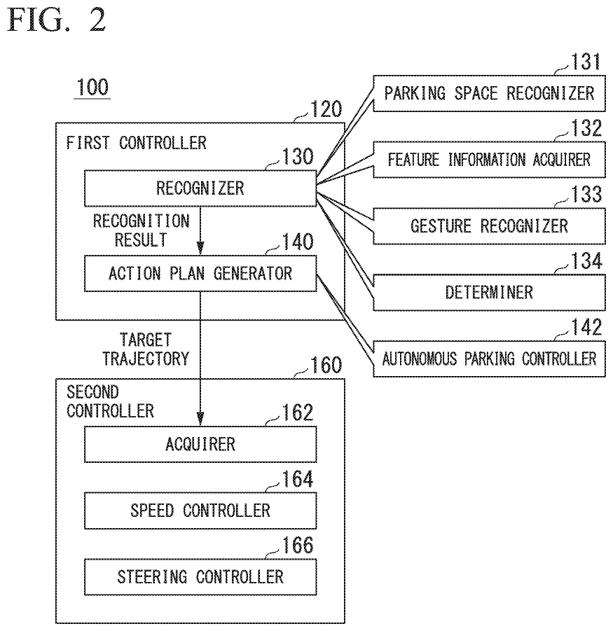

FIG. 2 is a diagram showing a functional configuration of the first controller 120 and the second controller 160. The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as positions, speeds, or acceleration of objects around the own vehicle M based on information input from the camera 10, the radar device 12, and the finder 14 via the object recognition device 16. For example, the positions of the objects are recognized as positions on the absolute coordinates in which a representative point (a center of gravity, a center of a driving shaft, or the like) of the own vehicle M is the origin and are used for control. The positions of the objects may be represented as representative points such as centers of gravity, corners, or the like of the objects or may be represented as expressed regions. A “state” of an object may include acceleration or jerk of the object or an “action state” (for example, whether a vehicle is changing a lane or is attempting to change the lane).

The recognizer 130 recognizes, for example, a lane in which the own vehicle M is traveling (a travel lane). For example, the recognizer 130 recognizes the travel lane by comparing patterns of road mark lines (for example, arrangement of solid lines and broken lines) obtained from the second map information 62 with patterns of road mark lines around the own vehicle M recognized from images captured by the camera 10. The recognizer 130 may recognize a travel lane by mainly recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M with respect to the travel lane when the recognizer 130 recognizes the travel lane. For example, the recognizer 130 may recognize a deviation from the middle of a lane of a standard point of the own vehicle M and an angle formed with a line extending along the middle of a lane in the travel direction of the own vehicle M as a relative position and posture of the own vehicle M to the travel lane. Instead of this, the recognizer 130 may recognize a position or the like of the standard point of the own vehicle M with respect to a side end portion (a road mark line or a road boundary) of any travel lane as the relative position of the own vehicle M to the travel lane.

The recognizer 130 includes a parking space recognizer 131, a feature information acquirer 132, a gesture recognizer 133, and a determiner 134 activated in an autonomous parking event to be described below.

The details of the function of the parking space recognizer 131, the feature information acquirer 132, the gesture recognizer 133, and the determiner 134 will be described later.

The action plan generator 140 generates a target trajectory along which the own vehicle M travels in future automatically (irrespective of an operation of a driver or the like) so that the own vehicle M is traveling along a recommended lane determined by the recommended lane determiner 61 and can handle a surrounding situation of the own vehicle M in principle. The target trajectory includes, for example, a speed component. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about a decimal point of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a low speed track traveling event, a lane changing event, a branching event, a joining event, a takeover event, an autonomous parking event in which unmanned traveling and parking are performed in valet parking, and the like. The action plan generator 140 generates the target trajectory in accordance with an activated event. The action plan generator 140 includes an autonomous parking controller 142 that is activated when an autonomous parking event is performed. The details of a function of the autonomous parking controller 142 will be described later.

The second controller 160 controls the travel driving power output device 200, the brake device 210, and the steering device 220 so that the own vehicle M passes along the target trajectory generated by the action plan generator 140 at a scheduled time.

Referring back to FIG. 2, the second controller 160 includes, for example, an acquirer 162, a speed controller 164, and a steering controller 166. The acquirer 162 acquires information regarding the target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination. A combination of the action plan generator 140 and the second controller 160 is an example of a “driving controller.”

The illumination controller 170 controls a lighting aspect of the headlight 70 based on a control state of the own vehicle M by the autonomous parking controller 142. The wiper controller 172 controls the wiper driver 72 such that the wiper 74 is driven based on a control state of the own vehicle M by the autonomous parking controller 142.

The travel driving power output device 200 outputs a travel driving force (torque) for traveling the vehicle to a driving wheel. The travel driving power output device 200 includes, for example, a combination of an internal combustion engine, an electric motor and a transmission, and an electronic controller (ECU) controlling these units. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor.

The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Autonomous Parking Event: at Time of Entrance]

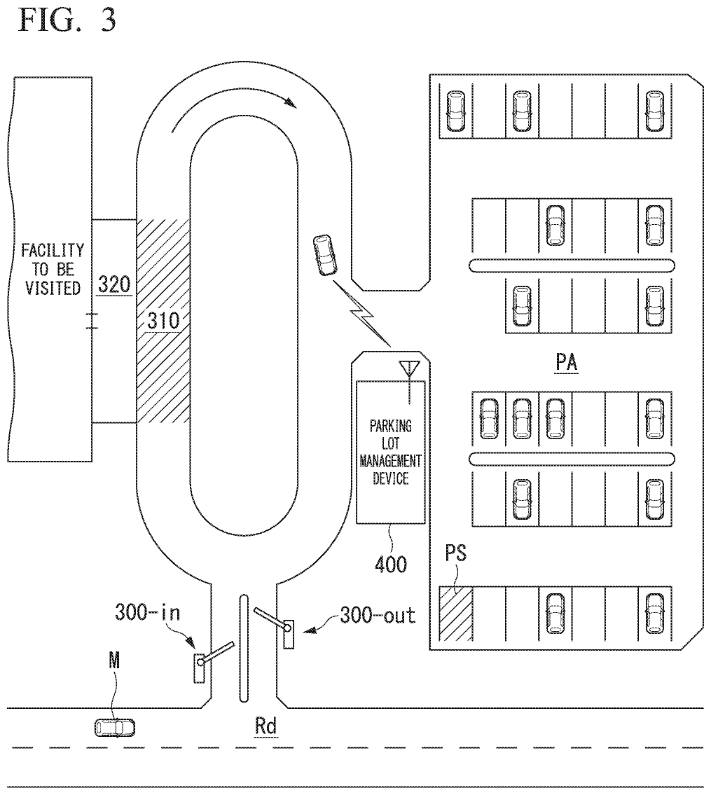

For example, the autonomous parking controller 142 parks the own vehicle M in a parking space based on information acquired from a parking lot management device 400 through the communication device 20. FIG. 3 is a diagram schematically showing a scenario in which an autonomous parking event is performed. Gates 300-in and 300-out are provided on a route from a road Rd to a facility to be visited. The own vehicle M passes through the gate 300-in through manual driving or automated driving and moves to a stopping area 310. The stopping area 310 faces a boarding area 320 connected to the facility to be visited. In the boarding area 320 and the stopping area 310, an eave is provided to block rain and snow.

After an occupant gets out of a vehicle in the stopping area 310, the own vehicle M performs unmanned automated driving and starts an autonomous parking event for moving to a parking space PS in a parking area PA. The details of a start trigger of the autonomous parking event related to a return will be described later. When the autonomous parking event starts, the autonomous parking controller 142 controls the communication device 20 such that a parking request is transmitted to the parking lot management device 400. Then, the own vehicle M moves in accordance with guidance of the parking lot management device 400 or moves performing sensing by itself from the stopping area 310 to the parking area PA.

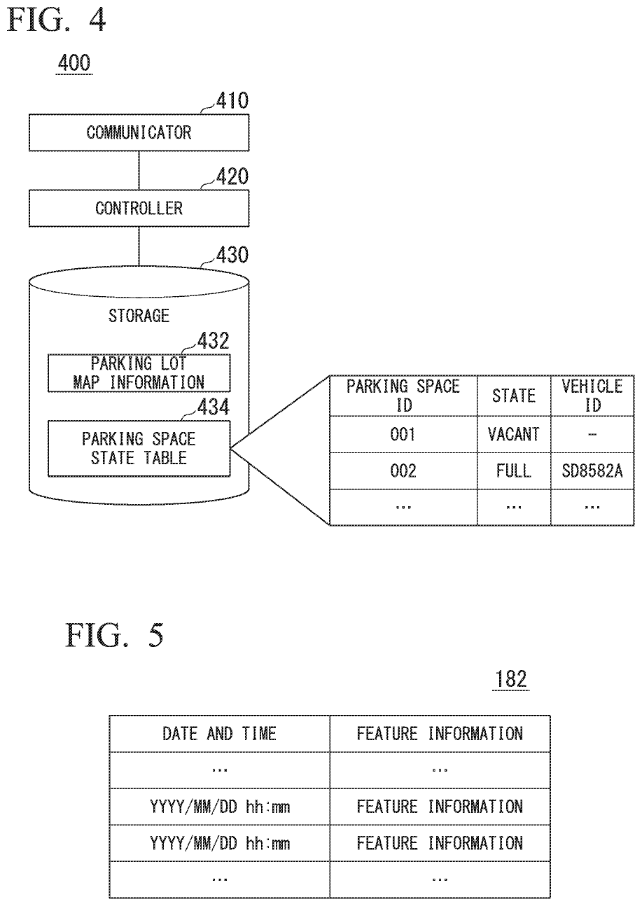

FIG. 4 is a diagram showing an example of a configuration of the parking lot management device 400. The parking lot management device 400 includes, for example, a communicator 410, a controller 420, and a storage 430. The storage 430 stores information such as parking lot map information 432 and a parking space state table 434.

The communicator 410 communicates with the own vehicle M and other vehicles wirelessly. The controller 420 guides a vehicle to the parking space PS based on information acquired by the communicator 410 and information stored in the storage 430. The parking lot map information 432 is information that geometrically represents a structure of the parking area PA. The parking lot map information 432 includes coordinates of each parking space PS. In the parking space state table 434, for example, a state which indicates a vacant state and a full (parking) state and a vehicle ID which is identification information of a vehicle parked in the case of the full state are associated with a parking space ID which is identification information of the parking space PS.

When the communicator 410 receives a parking request from a vehicle, the controller 420 extracts the parking space PS of which a state is a vacant state with reference to the parking space state table 434, acquires a position of the extracted parking space PS from the parking lot map information 432, and transmits a suitable route to the acquired position of the parking space PS to the vehicle through the communicator 410. The controller 420 instructs a specific vehicle to stop or move slowly, as necessary, based on a positional relation between a plurality of vehicles so that the vehicles do not simultaneously move to the same position.

In a vehicle receiving the route (hereinafter, assumed to be the own vehicle M), the autonomous parking controller 142 generates a target trajectory based on the route. When the own vehicle M approaches the parking space PS which is a target, the parking space recognizer 131 recognizes parking frame lines or the like marking the parking space PS, recognizes a detailed position of the parking space PS, and supplies the detailed position of the parking space PS to the autonomous parking controller 142. The autonomous parking controller 142 receives the detailed position of the parking space PS, corrects the target trajectory, and parks the own vehicle M in the parking space PS.

### [Autonomous Parking Event: Time of Return]

The autonomous parking controller 142 and the communication device 20 are maintained in an operation state even while the own vehicle M is parked. For example, when the communication device 20 receives a pickup request from the terminal device TM of an occupant, the autonomous parking controller 142 activates a system of the own vehicle M and causes the own vehicle M to move to the stopping area 310. At this time, the autonomous parking controller 142 controls the communication device 20 to transmit a launch request to the parking lot management device 400. The controller 420 of the parking lot management device 400 instructs a specific vehicle to stop or move slowly, as necessary, based on a positional relation between a plurality of vehicles so that the vehicles do not simultaneously move to the same position, as in the time of entrance. When the own vehicle M is caused to move to the stopping area 310 and picks up the occupant, the autonomous parking controller 142 stops the operation. Thereafter, manual driving or automated driving by another functional unit starts.

The present invention is not limited to the above description. The autonomous parking controller 142 may find a parking space in a vacant state by itself based on a detection result by the camera 10, the radar device 12, the finder 14, or the object recognition device 16, irrespective of communication and cause the own vehicle M to park in the found parking space.

[Stopping Own Vehicle M in Accordance with Gesture of Occupant P]

Here, the autonomous parking controller 142 causes the own vehicle M to automatically return from the parking lot PA in accordance with an autonomous parking event related to a return and causes the own vehicle M to stop near a person who is confirmed or predicted as the occupant P of the own vehicle M from the parking PA because of a performed predetermined gesture when the own vehicle M is caused to stop in the stopping area 310. The predetermined gesture is a gesture determined in advance as an instruction of causing the own vehicle M to stop and is, for example, a gesture of waving a hand to the own vehicle M to beckon the own vehicle M.

To perform this process, for example, the feature information acquirer 132 acquires an image obtained by causing the camera 10 to image a person (that is, the occupant P) near the own vehicle M at a timing at which the occupant P boards the own vehicle M (hereinafter referred to as a first timing) and store the acquired image and a date and time of the first timing in association with each other as outer appearance feature information 182 in the storage 180. FIG. 5 is a diagram showing an example of content of the outer appearance feature information 182. In the outer appearance feature information 182, for example, feature information indicating a feature of an outer appearance of the occupant P is associated with a date and time at which the feature information is acquired. The feature information is, for example, information obtained as a result of any image processing based on an image obtained by imaging the occupant P. When the image processing is performed, the feature information acquirer 132 generates a feature map or the like obtained using, for example, a convolution neural network (CNN) or the like and stores the feature map in the storage 180. In this case, the feature map is expected to indicate colors, a body type, and other rough features of the occupant P.

The feature information may be image data obtained by imaging the occupant P or may be information indicating the outer appearance of the occupant P. In this case, the feature information acquirer 132 causes a distance sensor or the like included in the own vehicle M to detect the outer appearance of a person near the own vehicle M and generates feature information. The feature information acquirer 132 may extract a contour or the like through edge extraction and set an extracted contour image as feature information or may generate feature information by applying the CNN or the like to the contour image.

For example, the gesture recognizer 133 recognizes a motion (hereinafter referred to as a gesture) of a part or all of the body such as a hand, the head, or the trunk of the person near the own vehicle M based on an image indicating the surroundings of the own vehicle M imaged by the camera 10 at a timing at which the autonomous parking controller 142 causes the own vehicle M to move to the vicinity of the stopping area 310 (hereinafter referred to as a second timing) in accordance with the autonomous parking event related to the return. For example, the gesture recognizer 133 recognizes representative points of the body in images of each frame and recognizes a gesture of the person based on a motion of the representative point in a time direction. The gesture recognizer 133 recognizes the gesture of the person by generating a learned model for outputting a type of gesture at the time of inputting of a moving image by deep learning and inputting an image indicating the surroundings of the own vehicle M imaged by the camera 10 to the learned model.

When the gesture recognizer 133 recognizes that the gesture is a predetermined gesture, the determiner 134 determines whether the person performing the gesture is the occupant P of the own vehicle M. The feature information acquirer 132 acquires an image obtained by causing the camera 10 to image the person near the own vehicle M even at the second timing. For example, the determiner 134 determines whether the person performing a predetermined gesture is the occupant P of the own vehicle M based on whether the feature of the outer appearance of the person performing the gesture matches the feature of the outer appearance of the occupant P of the own vehicle M indicated by the feature information registered in advance as the outer appearance feature information 182. Of the plurality of pieces of feature information included in the outer appearance feature information 182, the feature information used for the determination by the determiner 134 is feature information with which a recent date and time (that is, immediately before the second timing) before the second timing is associated therewith.

When the feature information is image data, the determiner 134 may generate a learned model outputting whether the features match at the time of inputting of the image of the person performing the predetermined gesture and the image of the occupant P of the own vehicle M by deep learning and perform determination using the learned model, or may compare the above-described feature maps with each other, calculate a generally accepted correlation coefficient level or the like, and determine that the person performing the predetermined gesture matches the occupant P of the own vehicle M (that is, the person is the occupant P) when the generally accepted correlation coefficient level is equal to or greater than a threshold.

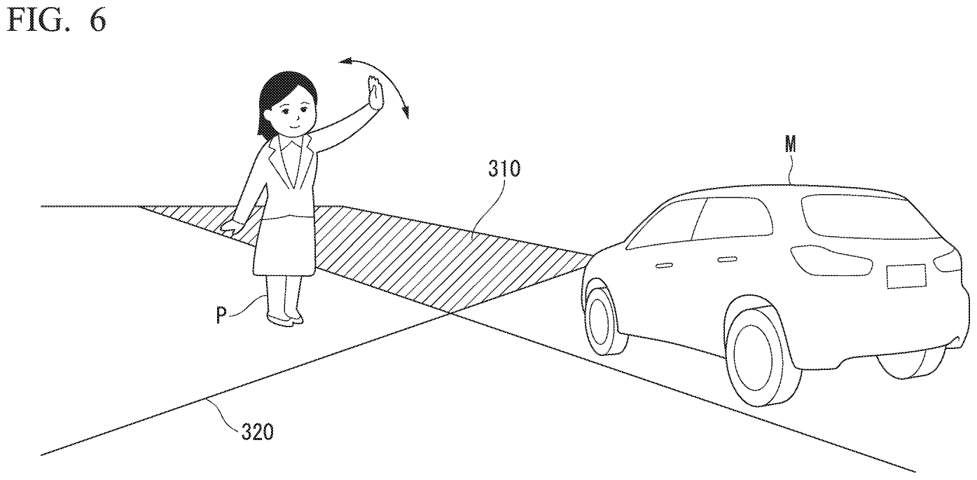

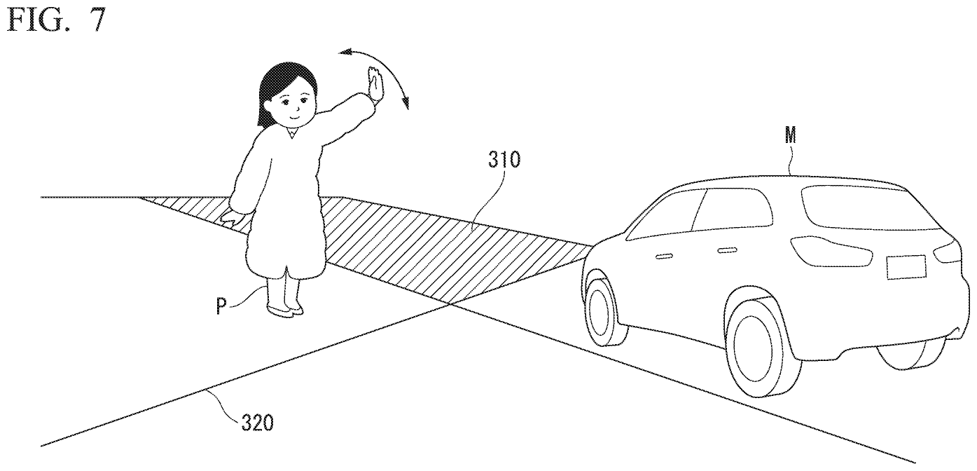

The autonomous parking controller 142 causes the own vehicle M to stop near the person determined to be the occupant P of the own vehicle M by the determiner 134. FIG. 6 is a diagram showing an example of a feature of an outer appearance of the occupant P at the normal time. FIG. 7 is a diagram showing an example of a feature of an outer appearance of the occupant P on a cold day.

Here, for example, in a season other than winter, the occupant P who is lightly dressed, as shown in FIG. 6, boards the own vehicle M. In winter, the occupant P who is heavily dressed, as shown in FIG. 7, boards the own vehicle M. Here, when the image obtained by imaging the occupant P included in the outer appearance feature information 182 is not a latest photo of the occupant P, the autonomous parking controller 142 cannot specify the occupant P even while the occupant P is performing a predetermined gesture in some cases. However, through the above-described process, the feature information acquirer 132 can acquire the feature information (that is, the latest photo) at the first timing and the second timing and the determiner 134 performs determination based on the feature information acquired by the feature information acquirer 132. Therefore, the autonomous parking controller 142 can cause the own vehicle M to stop near the occupant P with high precision in accordance with the predetermined gesture of the occupant P.

When the occupant P is not imaged appropriately in an image acquired immediately before the second timing, it is difficult for the autonomous parking controller 142 to specify the occupant P using the image. In this case, the autonomous parking controller 142 may use an image captured within a predetermined period (for example, several hours to several days) to specify the occupant P, instead of the image acquired immediately before the second timing.

When the autonomous parking controller 142 causes the own vehicle M to stop near the person determined to be the occupant P of the own vehicle M by the determiner 134, the illumination controller 170 may instruct the occupant P that the own vehicle M recognizes the occupant P by turning on an illumination in a predetermined lighting aspect. For example, the predetermined lighting aspect is determined in advance by the occupant P, for example, blinking the headlight 70 for a short time such as when passing, alternately blinking the right and left headlights 70, and blinking one of the right and left headlights 70.

[Operation of Own Vehicle M in Accordance with Gesture of Nearby Person]

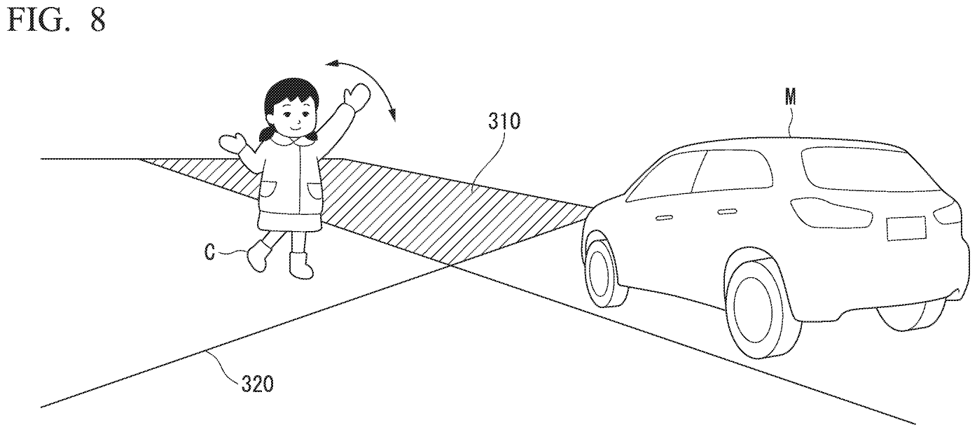

FIG. 8 is a diagram showing a scenario in which a person C other than the occupant P performs a predetermined gesture toward the own vehicle M. Here, when the autonomous parking controller 142 determines that the gesture recognized by the recognizer 130 is a predetermined gesture and the person C is not the occupant P based on an image obtained by causing the camera 10 to image the person C performing the predetermined gesture and an image indicating the occupant P included in the outer appearance feature information 182, the illumination controller 170 shows a response to the person C by turning on the headlight 70 in a predetermined lighting aspect. In this case, the illumination controller 170 may cause the lighting aspect of the headlight 70 for the occupant P to be different from a lighting aspect of the headlight 70 for the person C. Thus, the illumination controller 170 instructs the person C who is performing a predetermined gesture and is not the occupant P that the own vehicle M recognizes the gesture of the person C.

When the autonomous parking controller 142 determines that the person C is not the occupant P, the wiper controller 172 may show a response to the person C by controlling the wiper driver 72 and driving the wiper 74 in a predetermined driving aspect. The predetermined driving aspect is, for example, an aspect in which the wiper 74 wipes the front window a plurality of times. Thus, the wiper controller 172 can instruct the person C who is performing a predetermined gesture and is not the occupant P that the own vehicle M recognizes the gesture of the person C.

### [Operation Flow]

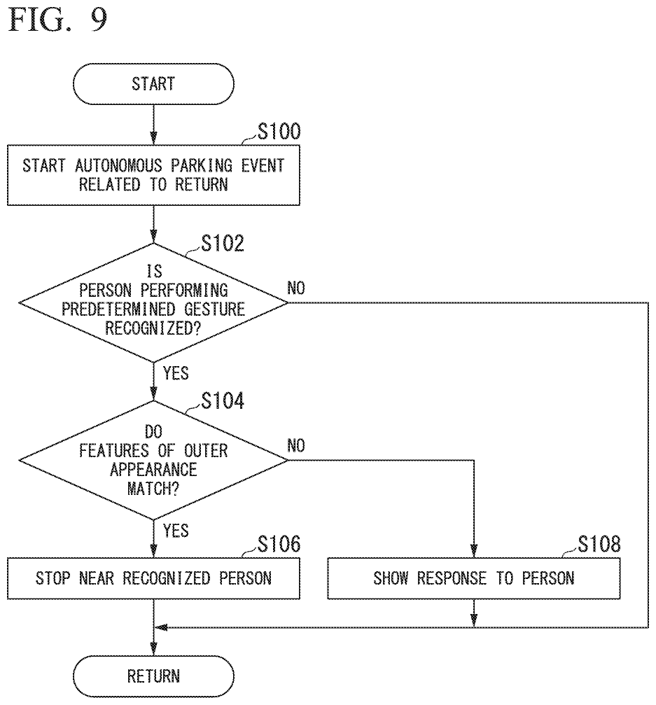

FIG. 9 is a flowchart showing an example of a series of operations of the automated driving control device 100 according to the embodiment. First, the autonomous parking controller 142 starts an autonomous parking event related to a return, causes the own vehicle M to return from the parking lot PA, and causes the own vehicle M to move to the vicinity of the stopping area 310 (step S100). The gesture recognizer 133 recognizes a person who is performing a predetermined gesture in the boarding area 320 (step S102). When the person who is performing the predetermined gesture is not recognized, the autonomous parking controller 142 ends the process and causes the own vehicle M to stop in the stopping area 310 through a basic process.

When the gesture recognizer 133 recognizes the person who is performing the predetermined gesture, the determiner 134 determines whether the feature of the outer appearance of the person matches the feature of the outer appearance of the occupant P based on the image obtained by imaging the person and acquired by the feature information acquirer 132 at the second timing and the image immediately before the second timing included in the outer appearance feature information 182 (step S104). When the determiner 134 determines that the feature of the outer appearance of the person matches the feature of the outer appearance of the occupant P, the autonomous parking controller 142 specifies the person as the occupant P and causes the own vehicle M to stop near the occupant P (step S106).

When the determiner 134 determines that the feature of the outer appearance of the person does not match the feature of the outer appearance of the occupant P, the autonomous parking controller 142 shows a response to the person by controlling the illumination controller 170 such that the headlight 70 is turned on in a predetermined lighting aspect or controlling the wiper controller 172 such that the wiper 74 is driven in a predetermined driving aspect (step S108).

### [Hardware Configuration]

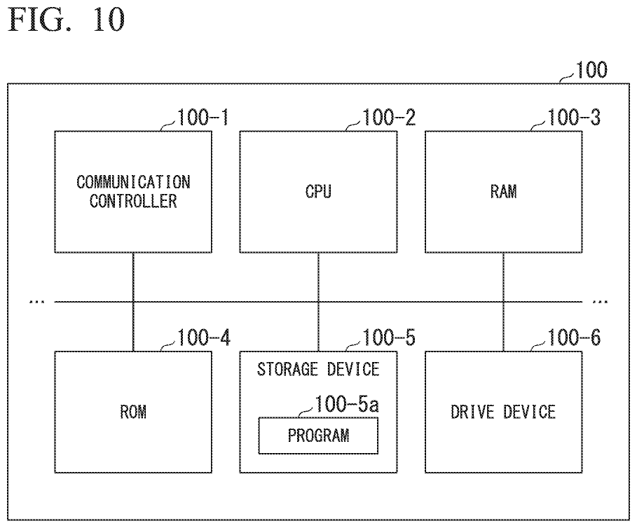

FIG. 10 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, some or all of the recognizer 130, the action plan generator 140, and the autonomous parking controller 142 are realized.

The above-described embodiment can be expressed as follows:

an automated driving control device including a storage device that stores a program and a hardware processor, the automated driving control device causing the hardware processor to execute the program stored in the storage device,

to recognize a surrounding environment of a vehicle;

to acquire a feature of the outer appearance of the person near the vehicle at a first timing at which the person boards the vehicle and store the feature of the outer appearance of the person near the vehicle in a memory;

to recognize a gesture of the person;

to automatically perform at least one of speed control and steering control of the vehicle based on a recognition result;

to determine whether the acquired feature of the person who is recognized to be performing a predetermined gesture matches the feature stored in the memory at a second timing (the second timing is later than the first timing); and

to cause the vehicle to stop near the person of which the features are determined to match when the features are determined to match.

While preferred embodiments of the invention have been described and shown above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognizer configured to recognize a surrounding environment of a vehicle;
a driving controller configured to perform at least one of speed control and steering control of the vehicle based on a recognition result of the recognizer;
an acquirer configured to acquire a feature of an outer appearance of a person near the vehicle and store the feature of the outer appearance in a memory;
a gesture recognizer configured to recognize a gesture of the person; and
a determiner configured to determine whether features of the outer appearance of the person acquired at different timings by the acquirer match,
wherein the determiner is configured to determine whether a feature of an outer appearance of the person acquired by the acquirer at a first timing at which the person boards the vehicle matches a feature of the outer appearance of the person acquired by the acquirer at a second timing which is a timing later than the first timing and at which the gesture recognizer recognizes that the person is performing a predetermined gesture, and
wherein the driving controller is configured to cause the vehicle to stop near the person of which the features are determined to match when the determiner determines that the features match.

2. The vehicle control system according to claim 1, wherein the determiner is configured to determine whether a feature at the first timing stored in the memory immediately before the second timing matches a feature acquired at the second timing.

3. The vehicle control system according to claim 1, further comprising:
an illumination controller configured to control an illumination provided in the vehicle,
wherein the illumination controller is configured to turn on the illumination in a predetermined lighting aspect when the feature acquired by the acquirer does not match the feature stored in the memory with regard to the person who is recognized to be performing the predetermined gesture by the gesture recognizer.

4. The vehicle control system according to claim 1, further comprising:
a driving controller configured to drive a movable part provided in the vehicle,
wherein the driving controller is configured to drive the movable part in a predetermined driving aspect when the feature acquired by the acquirer does not match the feature stored in the memory with regard to the person who is recognized to be performing the predetermined gesture by the gesture recognizer.

5. A vehicle control method causing a computer:
to recognize a surrounding environment of a vehicle;
to automatically perform at least one of speed control and steering control of the vehicle based on a recognition result;
to acquire a feature of an outer appearance of a person near the vehicle and store the feature of the outer appearance in a memory;
to recognize a gesture of the person;
to determine whether features of the outer appearance of the person acquired at different timings by the acquirer match;
to determine whether a feature of an outer appearance of the person acquired at a first timing at which the person boards the vehicle matches a feature of the outer appearance of the person acquired at a second timing which is a timing later than the first timing and at which the person is recognized to be performing a predetermined gesture; and
to cause the vehicle to stop near the person of which the features are determined to match when the features are determined to match.

6. A computer-readable non-transitory storage medium that is configured to store a program causing a computer:
to recognize a surrounding environment of a vehicle;
to automatically perform at least one of speed control and steering control of the vehicle based on a recognition result;
to acquire a feature of an outer appearance of a person near the vehicle and store the feature of the outer appearance in a memory;
to recognize a gesture of the person;
to determine whether features of the outer appearance of the person acquired at different timings by the acquirer match;
to determine whether a feature of an outer appearance of the person acquired at a first timing at which the person boards the vehicle matches a feature of the outer appearance of the person acquired at a second timing which is a timing later than the first timing and at which the person is recognized to be performing a predetermined gesture; and
to cause the vehicle to stop near the person of which the features are determined to match when the features are determined to match.
